(19) United States
(12) Patent Application Publication
(10) Pub. No.: US 2008/0044519 A1
(43) Pub. Date: Feb. 21, 2008

(54) Use of Ozone for Improving Kneading

(75) Inventors: Christian Coste, Loriol (FR); Michel Dubois, Buc (FR)

Correspondence Address: DENNISON, SCHULTZ & MACDONALD, 1727 KING STREET, SUITE 105, ALEXANDRIA, VA, 22314, US

(73) Assignee: GREEN TECHNOLOGIES SARL, Saint Malo (FR)

(21) Appl. No.: 10/598,871

(22) PCT Filed: Mar. 16, 2005
(86) PCT No.: PCT/FR05/00628

§ 371 Date: Nov. 16, 2006

(30) Foreign Application Priority Data
Mar. 19, 2004 (FR) 0402846

(51) Int. Cl. A21D 2/04; A21C 1/14

(52) U.S. Cl. 426/19; 366/100; 366/76.6

(57) ABSTRACT

The object of the present invention is a new method for kneading dough containing soft wheat flour, conducted in the presence of ozone and using at least one mechanical agitator (“fraser”). The dough so produced may be used to manufacture finished cereal bakery products such as loaves or related products (raised pizza dough for example).

A further object of the invention is new kneading devices adapted for kneading in the presence of ozone.

The object of the present invention is a new method for kneading dough containing soft wheat flour, in the presence of ozone. The dough made this way can be used to produce finished bakery cereal products such as loaves or related products (raised pizza dough for example).

A further object of the present invention concerns new kneading devices adapted for kneading in the presence of ozone.

### TECHNOLOGICAL BACKGROUND

Kneading is an operation which consists of the close blending of flour, water, a certain quantity of sodium chloride and leaven (or bakers' yeast) in the presence of air. Kneading can be considered a conventional chemical engineering operation which, from three basic products (flour, water and air), permits the forming of a homogenous, smooth, resistant dough having visco-elastic properties. The quality of the end products (baking products) depends largely upon the proper conducting of this operation.

By “flour” is meant a product obtained by fine grinding the grains of varieties of soft wheat. The average particle size of flour is 50 to 60 μm, the minimum size being approximately 6 μm and the maximum size approximately 220 μm.

On the other hand, the “meal” obtained from grinding hard wheat has a different particle size to flour, namely a mean particle size of approximately 600 μm, the minimum size being around 300 μm and the maximum size around 900 μm.

For industrial or semi-industrial kneading, dozens or even hundreds of kilograms of basic constituents may be kneaded during a kneading operation, the quantity of dough produced per hour generally exceeds 100 kg per hour and may exceed 1000 kg per hour with fast kneading devices (kneaders). The kneaders used for such kneading operations comprise a kneading bowl (or “kneader body”), a driving device and frasers. Fraser is the generic term to designate the mechanical moving part used for mixing in bread-making technology. A fraser may be defined as a specific moving mixer arm able to ensure all the operations of mixing, transmitting mechanical energy to the viscoelastic medium being formed, and pummelling this viscoelastic medium.

When the dough is formed, the two main components of flour i.e. starch and gluten, respectively account for 60 and 30% of the total volume of the dough, while the fraction of air added during the kneading phase corresponds to approximately 10% of this same total volume.

During the kneading operation, the constituents (water+flour+yeast+sea salt) are closely blended together in the presence of an oxidizing atmosphere (surrounding air). The addition of surrounding air to the dough during kneading is made by applying multiple mechanical stresses to the dough of mixing, agitation, folding and shearing type. The overall effect of these mechanical stresses is the permanent renewal of the interface between the dough being formed and the surrounding air, thereby ensuring the transfer of oxygen and nitrogen from the air towards the viscoelastic medium being formed. They have a twofold purpose:

to obtain a homogeneous structure having a particular consistency and special properties (viscoelastic properties);

to add and closely mix in air which contains the oxygen required to fulfill all the oxidation phases.

The oxygen, present in the gas incorporated during the kneading phase, acts via at least two priority routes which are:

direct action on the protein fractions (modifying the exchanges occurring within the dough between the disulfide groups of low and high molecular weight proteins);

use of this gas (oxygen) by oxidizing enzymes in particular: peroxidase, catalase, lipoxigenase. Via this route the small soluble proteins rich in cysteines are rapidly oxidized. The proteins with the highest molecular weight are then able to react, the consequence being an increase in the “strength” of the dough.

In parallel, oxidization of the thiol groups of the proteins leads to a change in the Theological properties of the dough. The Theological transformations observed are beneficial. They may translate as improved tolerance to kneading and a longer relaxation time, and hence finally to an increase in the volume of the bread. These changes are of especial importance under intensified kneading whose most visible effect is increased whitening of the breadcrumbs and an increase in bread volume.

It is important to note that the oxidation of the gluten proteins, and the other beneficial effects induced by oxygen throughout kneading, requires frequent renewal of contacts between the enzymes and substrates and a major energy supply.

One possible solution to facilitate the action of oxygen is to increase the absolute speed of interface renewal, and hence to increase the speed of rotation of the agitator (fraser) or agitators, and simultaneously to transmit higher mechanical energy. This conventionally used solution nonetheless has drawbacks and in particular the risk of final sticking of the dough through over-application of energy.

It is therefore difficult with conventional kneading techniques to control the supply of oxygen to the dough via mechanical mixing methods in order to obtain the beneficial effects of oxygen, whilst avoiding the disadvantages in terms of energy used and intrinsic problems (dough sticking).

The difficulty in controlling the supply and the effects of oxygen is heightened when using new fast kneading techniques of “Chorleywood process” type and similar methods developed in English-speaking countries. Continuous, short-term kneading only accentuates the difficulty in controlling gas transfer independently of mechanical aspects.

At the same time a certain number of special dough characteristics are of major interest and much sought after in the bread-making industry. Amongst these mention may be made of: good gas-retaining properties of the dough, good dough wettability (speed of water fixation), good machinability of the dough (dividing, shaping, tolerance), increased volume of the shaped dough during fermentation and baking, reduced risks of microbiological contamination. From the viewpoint of industrial management of dough production lines, simplification and increased parameter setting is desired for kneading and lesser variability in the characteristics of the products after kneading.

Patent application US 2004/0022917 describes a technology for obtaining a mixing time of the dough constituents (flour, water, etc.) of less than 10 seconds. This document teaches the injection of water under high pressure (30 to 100 bars) as a means to ensure mixing of the dough constituents to replace traditional mechanical means such as spiral mixers, worm mixers and dough hooks. Although it mentions the use of ozone as a potential contribution towards oxidation in the described technology, US 2004/0022917 does not teach kneading that is ensured by mechanical mixing arms in the presence of ozone.

Patent application RU 2 166 852 describes a method for kneading dough by mixing flour, treated water, salt and yeast in which, prior to mixing, ozone has been added to the water to remove contaminants. This document mentions that some impurities in the wetting water slow down yeast development; in addition some impurities intrinsically give rise to unpleasant odours. On leaving the fine purifying unit described in RU 2 166 852, the water which is to be used as wetting water no longer contains any ozone. Furthermore, it is explained that the use of excess ozone may have adverse effects on the organoleptic properties of the dough obtained. The quantity of ozone used is calculated and limited solely in relation to the quantity of impurities to be destroyed in the water, and RU 2 166 852 does not therefore describe a kneading method in the presence of ozonated water.

Patent application JP-3-175941 describes a method for preparing noodle dough. The main objective of this patent application is to reduce the quantity of sodium chloride used in noodle manufacture on account of its propensity to cause the onset of circulatory diseases. The solution put forward in this document is to use whey (the fraction separated from curdled milk in cheese making) as whey contains various mineral salts and can be used to manufacture noodles reducing the quantity of NaCl. In this method the whey may impart a cheese smell to the noodles produced and, to remove this particularly unacceptable smell from the noodles, it is recommended to treat a solution of mineral salts of the whey with ozone. Ozone is passed at a basic pH in the presence of organic matter reacting with the ozone and in a saline solution. These factors all promote the reaction or decomposition of the ozone and therefore, at the time of kneading, there is no longer any ozone in solution. As is the case in RU 2 166 852, under the operating conditions of this method no trace of ozone exists at the time of contact with the flour—neither of these cases relates to a kneading operation using ozonated water. In both cases the only role allocated to ozone is a role of decontamination/deodorization. It can also be noted that patent application JP-3-175941 specifically relates to a production process for (Japanese) noodles which are produced from hard wheat, and not to a process for manufacturing dough from soft wheat for subsequent bread making.

Patent application GB 186 940 describes the use, as flour milling additives, of organic compounds (peraldehydes, (per)ozonides etc.) obtained by the reaction of ozone on precursor molecules. The addition of ozone itself during kneading is neither described nor suggested in this document.

Documents FR 2 831 023, GB 880 182, DE 1 96 24229 and U.S. Pat. No. 5,089,283 concern mechanical details for kneading machines and kneading methods using the same. In particular, these documents describe methods for controlling the supply of oxygen to the dough. On the other hand, none of these documents neither describes nor suggests the use of ozone during a kneading operation.

International application WO 01 43556 concerns a method for producing flour having a high food safety level, comprising the crushing of previously cleaned, moistened grains characterized in that prior to or simultaneously with grinding said grains are contacted with ozone. In this method the ozone is therefore applied to the grains before or at the same time as they are ground, and is not applied to the flour. WO 01 43556 therefore relates to a method for preparing flour (which may subsequently to be used for a kneading operation), and not to a kneading method using the already ground flour.

### SUMMARY OF THE INVENTION

The Applicant has now discovered that it is possible to solve the above-indicated problems by a method for kneading dough containing soft wheat flour, characterized in that the kneading operation is conducted in the presence of ozone and using at least one mechanical agitator (“fraser”).

In a preferred embodiment of the invention, the agitation used to mix the dough constituents (water, flour . . . ) is solely produced by at least one mechanical agitator (“fraser”) excluding any mixing systems using the injection of water under high pressure.

The ozone, which may be conventionally produced from oxygen in an ozonator, may be added to the dough in two manners:

the wetting water added to the dough may be previously ozonated;

the ozone may be supplied to the gaseous headspace of the kneading machine i.e. the gas atmosphere in contact with the solid and liquid phases of the dough being prepared.

It is possible, and advantageous, to supply the ozone via each of these routes used separately or in combination. In addition, as will be detailed below, the ozone may be supplied selectively, sequentially, continuously or through the use of successive sequences of ozone supply via liquid route and gas route.

According to a further aspect of the invention, the applicant made adaptations to kneading machines known to persons skilled in the art in order to enable kneading in the presence of ozone. “Conventional” kneading devices with limited mixing speeds were adapted to allow kneading in the presence of ozone as well as continuous, fast kneading machines with high mixing speeds.

Amongst the advantages provided by the kneading process of the invention compared to conventional kneading processes, mention may be made of:

reduced kneading time at a given mixing speed, or reduced mixing speed for a given time. In both cases the energy used for kneading is reduced;

improved gluten network structure despite the use of lower mechanical energy;

improved CO₂ production and retaining properties during dough fermentation;

improved dough wettability;

improved “machinability” of the dough i.e. better capacity for proper working and shaping;

increased microbiological quality.

With the use of ozone it is also possible to meet a certain number of requirements in respect of the industrial management of dough production, and in particular:

reduced risk of dough sticking;

simplification and increased parametrizing of kneading;

lesser variability in product characteristics after kneading.

### BRIEF DESCRIPTION OF THE FIGURES

FIG. 1 schematically shows a “conventional” kneading device, not having a very high mixing speed and not adapted to the use of ozone during kneading.

FIG. 2 schematically shows an example of a “conventional” kneading machine not having a very high mixing speed and comprising adaptations for the use of ozone during kneading according to the present invention.

FIG. 3 schematically shows a “continuous” kneading device (for fast kneading) with a high mixing speed and not adapted for the use of ozone during kneading.

FIG. 4 schematically shows an example of a “continuous” kneading device (for fast kneading) having a high mixing speed comprising adaptations for the use of ozone during kneading according to the present invention.

FIG. 5 is a graph showing the improvement in the gas producing and retaining properties of dough treated with ozone according to the present invention, compared with dough not treated with ozone, as measured by rheo-fermentometer.

FIG. 6 is a curve showing the improvement in machinability and tolerance of dough treated with ozone according to the present invention, compared with dough not treated with ozone as measured by consistograph.

### DETAILED DESCRIPTION OF THE INVENTION

As mentioned above, kneading is an operation consisting of closely blending flour, water, a certain quantity of sodium chloride and leaven (or yeast) in the presence of air.

During a conventional kneading operation, a quantity of water of between 50 and 65 kg is added per 100 kg of initial flour. Usually, initial flour has a water content of between 8 to 14%. The total, final quantity of water with respect to flour dry matter therefore generally ranges from 60 to 85%, most often between 65% and 75%, since flours that naturally have the highest moisture require the addition of less water.

In the framework of the present invention, the final, total quantity of water with respect to flour dry matter, taking into consideration the initial humidity of the flour, is preferably between at least 60% and no more than 75%.

The quantity of sea salt is generally in the order of 2% by weight, i.e. 2 g NaCl per 100 kg flour. It is to be noted that salt plays an organoleptic role but also has an influence on the technological properties of the finished products. Other salts may be added but in this case they will be special additives.

Also fresh yeast is generally used in a quantity of approximately 2% by weight with respect to the flour, i.e. 2 kg per 100 kg flour.

Kneading is generally conducted at room temperature. Although it may be conducted at other temperatures, generally few effects are observed related to a change in temperature. Concerning kneading conducted in the presence of ozone according to the present invention, no effect related to a change in temperature was observed.

The ozone required for carrying out the present invention is typically produced by passing a vector gas through an ozone generator (ozonator). The vector gas must necessarily contain a sufficient fraction of oxygen to enable the fabrication of ozone under acceptable conditions in terms of energy and economy. Either air or pure oxygen may be used or a mixture of these two gases in variable proportions. When passing in the ozonator, the fraction of oxygen contained in this vector gas is converted, at least in part, into ozone.

The applicant has found that appropriate concentrations of ozone in the vector gas, irrespective of the type of gas, are usually advantageously chosen to be between 5 g O₃/m³ tpn and 250 g O₃/m³ tpn, more preferably between 15 g O₃/m³ tpn and 150 g O₃/m³. These values of ozone concentration in the vector gas are given for guidance purposes and are non-limitative, in particular having regard to the diversity of manners in which the ozone may be added to the dough as will be seen below.

If the ozone is supplied by the wetting water, this water must be previously ozonated, or even hyper-ozonated.

The ozone concentration of the ozonated water and hyper-ozonated water chosen under the present invention may vary, in particular in relation to the type of kneading machine, the volume of dough being kneaded and the characteristics of the finished product it is required to obtain. Generally, and to tally with the quantities of water added per dough weight, the ozone concentration in the water expressed in milligrams of ozone per litre of water lies between 20 mg/l and 100 mg/l, preferably between 40 mg/l and 80 mg/l. These values do not depend upon the exact temperature of the water in which the ozone was dissolved.

The preparation of ozonated or hyper-ozonated water requires the use of a device able to operate under very light pressure (1.5 absolute bars) or higher pressure (up to 2.2. absolute bars). With the use of special devices known to persons skilled in the art, it is possible to dissolve ozone in water under higher pressures but generally at the cost of a slight loss of ozone which may bring a slight reduction in the overall yield of the operation.

As a non-restrictive example, the ozonated or hyper-ozonated water may be produced using devices whose description follows.

For preparing ozonated water, any type of dissolving reactor may be used comprising porous diffuser bubbling devices, with a sufficient height of liquid to ensure transfer of the gaseous ozone in liquid phase (application pressure).

Dissolution of ozone in a reactor subjected to a mere liquid load limits the quantity of dissolved ozone (the liquid load is limited by the height of the reactor). This ozone dissolution device may be used to supply small quantities of ozone to the kneading machine, and therefore low quantities of ozone conveyed via the wetting water.

If the quantity of ozone to be used is greater and has to be added to the kneading machine within a relatively short time, it is necessary to use so-called hyper-ozonated water. For this purpose a device may be used having geometrically acceptable characteristics and able to dissolve, under pressure, the quantities of ozone needed for the kneading phase.

The first device which persons skilled in the art may use consists of an ozone reactor with porous disc device whose gaseous headspace is maintained under pressure. The additional pressure exerted on the column of water contained in the reactor substantially increases the application pressure of the ozone and hence the driving dissolution pressure (driving transfer pressure).

The second solution for preparing hyper-ozonated water consists of using a static, single or multistage device of hydro-ejector type, making it possible to add a substantial gas volume under moderate application pressure. This type of device provides high dissolution rates and enables the dough under formation to be supplied with the required quantities of ozone in a low volume of water.

These devices can be applied irrespective of the type of vector gas carrying the ozone: air, oxygen, mixture of the two gases in variable proportions.

Persons skilled in the art, in relation to the quantities of ozone to be added, will be able to determine the number of stages and the size of hydro-ejector to be used.

Other devices may be used to produce hyper-ozonated water. These are devices using the compression of ozonated gas before it is added in liquid phase, or devices with which it is possible simultaneously to compress the ozone and dissolve it in liquid phase. Among these devices it is possible to use pressure boosters or machines of similar type. As examples of machines whose size is compatible with the processes of the present invention, the models marketed by SIHI and Allimand may be cited. The use of these types of machines slightly deteriorates the energy yield of the operation since these machines have a non-negligible, additional energy consumption.

The other route for adding ozone to the dough consists of adding a vector gas containing the ozone to the gaseous headspace of the kneading machine. The ozone may be added in a single operation (for example if the kneading machine, in fact the “reactor”, is then closed), or by continuous passing of the vector gas through the kneading machine.

As mentioned above, the ozone may be added both via the wetting water added to the flour, and by incorporation of the ozone contained in the vector gas in the gaseous headspace of the kneading machine. The ozone may be added selectively, sequentially, continuously or through the use of successive sequences of ozone supply via liquid route and gaseous route.

Preferably, the first addition of ozone is made in a water medium, since dough formation comprises a first hydrating phase of the flour. Once the dough is formed and the first oxidation reactions occur, the second addition of ozone may then advantageously be made via a gaseous medium (i.e. by incorporation of the ozone in the gaseous headspace of the kneading machine). At this moment kneading is conducted in an ozone atmosphere, and the transfer is made into the visco-elastic structure formed by the dough. Additional hydration during kneading may prove to be useful for supplying an additional quantity of ozone.

During the wetting phase, a fraction of ozone may be added via aqueous route and a fraction of ozone via gaseous route simultaneously, whereas during the kneading phase the ozone may be added continuously via gaseous route. It can also be contemplated to add the ozone via aqueous route and via gaseous route in short successive sequences during the first kneading phase. The technique chosen to add the ozone is chosen in relation to the characteristics of the kneading equipment used and especially in relation to the desired characteristics of the finished products (baking products) to be obtained.

The process of the present invention may be conducted using a closed kneading device (kneader) able to operate under a slight vacuum even under pressure. It is to be noted that some types of kneading machines are currently available on the market which operate under a slight vacuum during a first phase (first kneading phase) then under light pressure during a second phase, or optionally under atmospheric pressure. This type of kneading machine may also be used for the invention developed by the applicant, since ozone in gaseous form or additional ozonated water may be added during the second kneading phase either under light pressure or under atmospheric pressure or a higher pressure for the gaseous form, or during the first and/or second phase for the ozonated water.

In the framework of the present invention, at the time the ozone is added the pressure prevailing in the gaseous phase of the kneading machine preferably lies between at least 1.1. absolute bars and no more than 1.6 absolute bars. More preferably, the pressure in the gaseous phase lies between at least 1.3 absolute bars and no more than 1.5 absolute bars, the most preferred value being approximately 1.4 absolute bars. Regarding the pressure of the wetting water (which may be ozonated water) the pressure preferably ranges from at least 0.5 absolute bars to no more than 2.2. absolute bars, more preferably between at least 1.7 absolute bars and no more than 1.9 absolute bars, the most preferred value being approximately 1.8 absolute bars.

The use of ozone carried by water used for wetting the flour, or by a gas vector able to be added to the kneading machine, is not limited to the use of conventional kneading equipment. The invention of the applicant may be applied to any modern, fast kneading device insofar as said device can be partly sealed. This concerns devices of “Chorleywood process” type, Amflow® and Do-Maker® continuous processes and any other process allowing fast, even very fast kneading (400 revolutions per minute) within a limited time.

However, under the present invention, the agitation which allows mixing of the dough constituents (water, flour, . . . ) is preferably ensured solely by means of at least one mechanical agitator (“fraser”), without any use of mixing systems using high pressure water injection.

Regarding kneading machines, it is possible to divide known machines into two categories. Firstly so-called “conventional” or “discontinuous” kneading machines exist in which the speed of rotation of the agitators is not very high (normally between 40 and 80 rpm, even though some models may reach 200 rpm). Secondly, so-called “continuous” or rapid kneading machines exist in which the speed of rotation of the agitators is high, generally more than 100 rpm and possibly reaching 600 rpm.

With respect to “conventional” kneading machines, the agitators (“frasers”) may have an oblique axis, in which case the revolving of the kneading bowl may be free or motorized. It is also possible to use vertically set agitators of spiral shape, in which case the revolving of the kneading bowl is generally motorized. It can also be noted that the axis of symmetry of the bowl is normally vertical for “conventional” kneading machines; nevertheless a few rare models of horizontal discontinuous kneading machines exist.

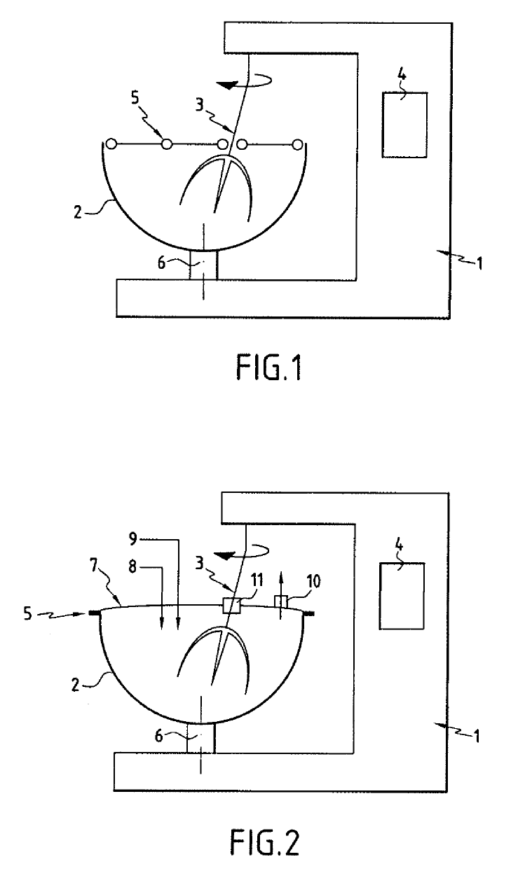

An example of a conventional kneading machine is schematically shown FIG. 1.

In this conventional kneading machine, a frame 1 generally made in cast iron or mechanically welded structure, carries the mechanical driving device (motor, speed regulator, gear) and the kneading bowl 2 which is generally in stainless steel. When in operation, the bowl 2 is rotated slowly or is given free rotation by means of a driving or support device 6.

Inside the bowl 2, an agitator (“frasers”) 3 intended to ensure the mixing and application of mechanical stresses is driven by a rotational movement whose speed is between 40 and 80 rpm. As indicated above agitators may be of two types, namely with an oblique axis or a vertical axis (generally spiral).

The top part of the kneading bowl can be closed by a safety device 5 or a sealing lid ensuring a closed system with the kneading bowl. The frame 1 contains the control and regulation panel 4.

For use of said conventional kneading machine, before the actual kneading operation, the flour, water, sea salt (sodium chloride) then the yeast are placed in the bowl before mixing.

In the framework of the present invention, the Applicant has conducted studies to determine how to perform kneading in the presence of ozone, both for conventional kneading and for fast kneading.

An example of the adaptation of a conventional kneading machine for the use of ozone according to the invention is schematically shown FIG. 2.

Parts 1 to 6 of the kneading machine have the same meaning as for the conventional non-adapted kneading machine described above with reference to FIG. 1, part 5 however forming a sealing device.

According to the invention, this machine is completed by a sealed lid 7, a gaseous ozone inlet 8 and/or an ozonated or hyper-ozonated water inlet 9, a discharge outlet 10 and a sealed passage 11 around the agitator (“fraser”) 3. Preferably the sealed passage 11 is formed of a compressible seal allowing the impervious passing of the agitator 3.

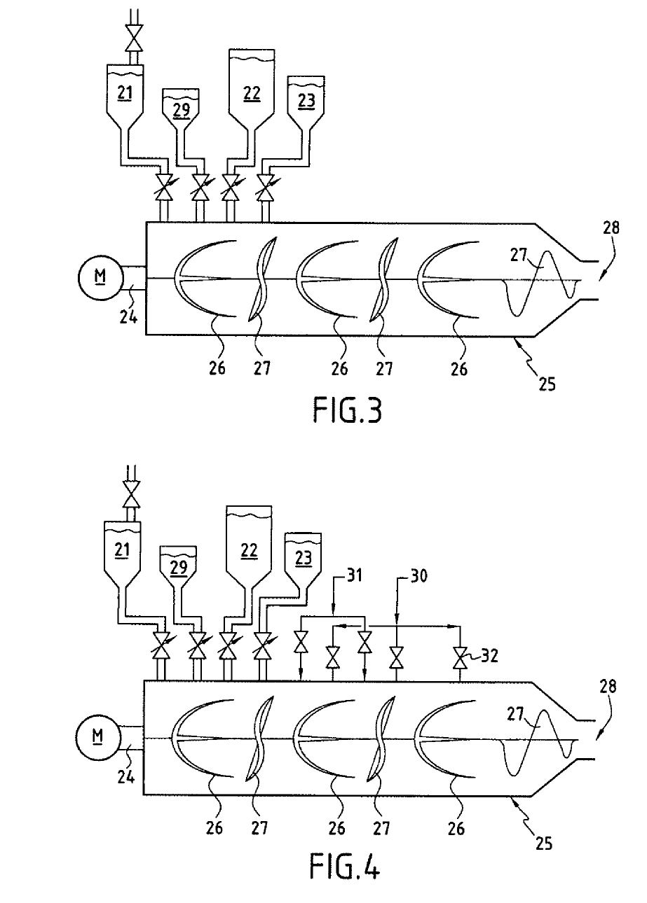

Regarding the machines for continuous kneading (fast kneading) an example of a continuous kneading machine not adapted for use of ozone is schematically shown in FIG. 3.

The key constituent parts of this kneading machine are the following:

a water reservoir 21 containing the water required for wetting the flour, connected to the body of the kneading machine by piping provided with a regulating valve;

a flour reservoir 22 to stock and dispense the flour inside the body of the kneading machine. This reservoir is also connected to the body of the kneading machine by piping provided with a regulating valve;

a yeast reservoir 23 containing the yeast required for dough fermentation, also connected to the body of the kneading machine by piping provided with a regulating valve;

a reservoir for sea salt NaCl 29 containing the salt needed for kneading the dough, also connected to the body of the kneading machine by piping provided with a regulating valve;

the body of the kneading machine 25 consisting of a cylindrical device a with horizontal axis, normally made in stainless steel, comprising at one of its ends a cylindrical-conical device provided with an opening 28, generally cylindrical, for discharging the prepared dough. At the other end is the motorization and driving device 24 to drive a central shaft carrying the kneading devices frasers 26 and the devices for conveying the dough forwards 27.

During the kneading phase, the flour, wetting water, sea salt and yeast are added in predetermined quantities to the first zone of the kneader where mixing takes place and the first working phase. The formed dough is taken up by the dough conveyors 27 and pushed towards the other kneading zones comprising kneading agitators (“frasers”) 26. Finally, the dough ready for use is pushed outside the body of the kneader by a conical screw device. Generally the regulating valves positioned between the storage devices and the body of the reactor are regulating valves of automatic type with sequence control.

In one variant of this embodiment, a continuous kneading machine (for fast kneading) may consist of a cylindrical body with horizontal axis comprising an Archimedes screw device on its inner periphery enabling the forward movement of the dough towards the outlet. The agitators (“frasers”) remain retained on the horizontal driving shaft, but in this variant the forward movement of the dough is separated from the actual kneading operation.

An example of the adaptation of a continuous kneading machine (for fast kneading) to the use of ozone according to the invention is schematically shown FIG. 4.

Parts 21 to 29 of the kneading machine have the same denotation as in the fast kneading machine described above with reference to FIG. 3. According to the invention, this device is completed by an inlet for gaseous ozone 30 and/or an inlet for ozonated or hyper-ozonated water 31 and a regulating valve 32.

The Applicant has observed that the quantity of ozone added to the dough is an important parameter characterizing the methods of the present invention.

Typically the quantity of ozone added is measured and expressed in grams of ozone added per hour with respect to the quantity of dough (in kilograms) produced per hour. Preferably, between 0.004 and 0.06 g ozone (O₃) is added per kg of dough produced, on the understanding that this measurement relates to the weight of the finished dough after its wetting during kneading. The exact quantity of ozone to be added depends firstly upon the industrial type of kneading and secondly on the exact qualities sought for a given dough.

Table 1 below shows the quantities of ozone to be added per unit of time in relation to the kneading method used.

TABLE 1
Quantity of zone to be added per unit of time in
relation to method

| | | | | Typical |
|---|---|---|---|---|
| | | Industrial | Industrial | American |
| | | traditional | standard | industrial |
| | Units | bread | bread | bread |
| Quantity of | kg/hour | 250 | 1,000 | 6,000 |
| dough | | | | |
| produced | | | | |
| Mean qty. | g O₃/hour | 1.2-12 | 5-60 | 30-200 |
| of ozone to | | | | |
| be added to | | | | |
| the dough | | | | |

For each of these qualities of finished product, the quantities of dough produced, expressed in kg per hour, were chosen as being those typically corresponding to standard productions of industrial processes used for this type of product. The quantities of ozone indicated may vary in relation to flour type and quality, typically related to the origin of the wheat. For example, for industrial traditional bread kneaded using a conventional semi-industrial method with an hourly dough production of 250 kg, between 1.2 and 12 g of ozone must be used per hour in relation to the characteristics of the flour, the type of kneading machine used and final quality of the bread.

### Results

### Reduction in Energy Costs

The Applicant found that, compared with conventional kneading methods, kneading in the presence of ozone according to the invention makes it possible to reduce energy costs.

Firstly, for the same kneading speed, an acceleration in the speed of dough formation is observed. For example, for kneading qualified as being of “improved” quality and for a first kneading speed of 40 rpm, the kneading time observed with conventional technology ranges from 3 to 4 minutes. This same time, all other parameters being equal, is reduced to a time of between 2 and 3 minutes when kneading is performed in the presence of ozone. Kneading of improved type generally comprises a second kneading speed in the region of 80 rpm. Under these operating conditions, and in conventional technology, the kneading time is generally between 10 and 12 minutes. It is reduced to a range of between 7 and 9 minutes when kneading is performed in the presence of ozone. The Applicant noted that these results are confirmed with kneading of “intensive” and “hyper-intensive” type and that the reduction in kneading time at constant kneading speeds typically lies between 16% and 27% of the initial kneading time (in conventional methods).

Although the exact kneading time strongly depends upon the type of kneading machine used, for kneading in the presence of ozone using at least one mechanical agitator according to the present invention, the time is generally preferably more than 2 minutes.

Also if the kneading time and quality of the obtained dough is fixed, it is observed that the use of ozone, for similar results regarding dough quality, enables a reduction in the speed of rotation of the mixing arms. For example for kneading qualified as being “improved” the conventional speed of the second kneading phase is close to 80 rpm. When ozone is used during kneading, the speed of rotation of the agitators, for the same kneading technique, can be substantially reduced to the range of between 64 rpm and 67 rpm. As a general rule it is observed that the speeds of rotation, for the same kneading time, may be reduced with the help of ozone over a range of 18% to 27%.

As will be easily understood by persons skilled in the art, the overall reduction in energy consumed during kneading with the addition of ozone typically lies between 15% and 23% of the initial energy that is traditionally used.

### Rheo-Fermentometer Study

To study the effect of ozone on the viscoelastic structure of the dough and in particular of the constituents of the gluten network, the Applicant had recourse to the rheo-fermentometer technique. In this technique the volume of carbon gas (CO₂) produced is measured together with the volume retained in the dough. The difference between the two, representing the volume of released CO₂, can then be determined. It is considered that this measurement method can give indirect information on the extent of oxidation of the gluten network.

In FIG. 5 the four curves relate to:

A—Global CO₂ production by the dough, measured on a sample treated with ozone;

B—Gaseous CO₂ retention in the dough (sample treated with ozone);

C—Global CO₂ production by the dough (reference sample not treated with ozone); and

D—Gaseous CO₂ retention in the dough (reference sample not treated with ozone).

The coordinate axes of these four graphs evidence the gaseous volumes produced or retained by the dough, expressed in 10⁻³ litres (Y-axis) and the time, limited to the same value for the four graphs, expressed in hours (X-axis).

The comparison between these four graphs shows that, for an identical follow-up and measurement time, the dough treated with ozone releases more CO₂ than the non-treated dough (comparison of graphs A and C) which clearly demonstrates a better oxidation process inducing greater fermentation.

The comparison of graphs B and D shows better gaseous retention by the dough treated with ozone compared with the non-treated reference over the same observation time.

The difference between the CO₂ production and retention curves (indicating the volume of released CO₂) is smaller for the sample treated with ozone compared with the non-treated sample.

### Study Using a Consistograph

The consistograph is the most suitable tool for measuring dough consistency and dough formation time, in almost identical manner to industrial conditions. With this equipment it is possible to determine to which extent kneading in the presence of ozone makes it possible to achieve better machinability of the dough (dividing and shaping) and better tolerance of the dough.

In a consistograph, the coordinate axes evidence the measurements made and recorded, namely on the Y-axis the pressure expressed in 10⁻³ bar and on the X-axis the time expressed in seconds. The comparison between the two graphs gives the difference in pressure exerted by the kneaded sample on the walls of the mini-kneader, which indirectly evidences the development of the dough, its consistency and therefore its subsequent machining capacity.

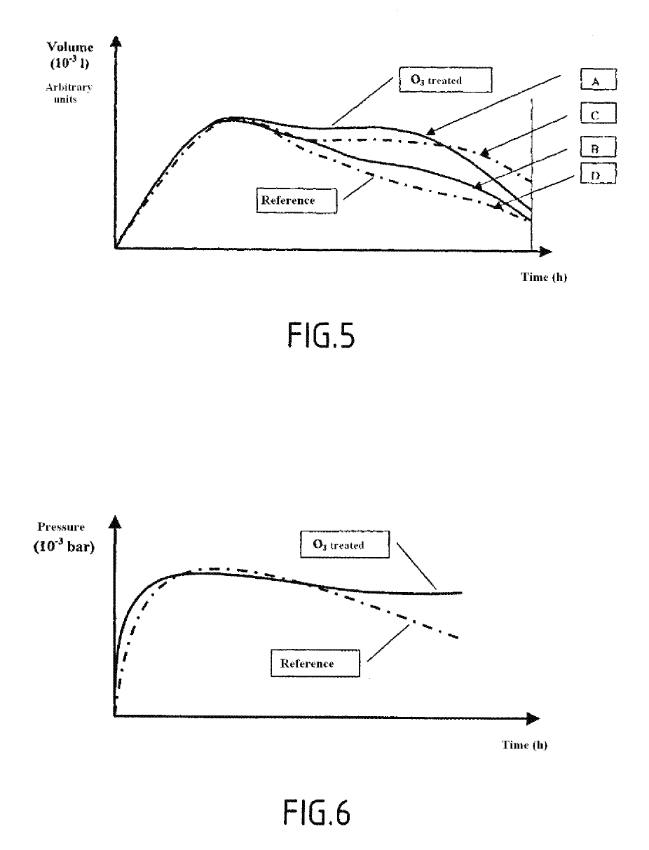

The results obtained by the applicant are given by the curves in FIG. 6, of which one relates to the reference sample not treated with ozone during the mini-kneading phase and the other relates to the reference sample treated with ozone during the mini-kneading phase.

Observation of these two graphs shows that the pressure of the sample treated with ozone during its kneading rises faster than that of the non-treated sample and that, for almost identical maximum pressure, the pressure of this sample decreases more slowly than the pressure of the non-treated sample.

Kneading in an ozone atmosphere therefore imparts to the dough obtained a marked propensity for better subsequent machinability and greater tolerance (preserving of qualities in relation to kneading time during subsequent handling, transport or shaping operations).

By way of example the Applicant describes below a case of use relating to the invention.

### EXAMPLE

50 kg of soft wheat 55-type flour (water content 13%, protein percentage with respect to the dry matter (DM) 11.4%), 1.0 kg of yeast and 500 g of sea salt were added to a kneading machine of REX type with a fixed bowl (VMI trade name) model LEW/GLEW that was modified to ensure kneading in an ozone atmosphere. Modification consisted of using a stainless steel lid allowing the sealed passing of the agitator, and ensuring peripheral imperviousness with the bowl by means of a compressible seal. The sealing lid was attached to the kneading bowl via a circular flange comprising a flexible seal and a guide system to enable positioning of the lid with respect to the kneading bowl. The whole was held in position by mobile fast-clamping devices of mobile autoclave type. On the lid an inlet for gaseous ozone was arranged fitted with a regulating valve, and an inlet for ozonated or hyper-ozonated water fitted with a regulating valve, and an outlet or drain for the gaseous headspace provided with a cut-off valve.

1440 mg of ozone were added to the kneading machine after prior dissolving of this quantity of ozone in 30 litres of ozonated water, prepared in accordance with the invention (wetting water). This first addition of ozone added to the wetting water required for kneading made it possible to provide the dough with 18 mg of ozone per kg of dough (weight of dough in the kneading bowl: 80 kg). After 2 minutes 45 seconds of fraisage (pre-kneading phase) at a rotation speed of 40 rpm for the agitators (“frasers”), the kneading machine was stopped and the gaseous headspace filled with 30 litres of oxygen previously ozonated to a concentration of 80 mg O₃ per litre of vector gas. The quantity of ozone supplied by the vector gas in the gaseous headspace therefore corresponds to 2400 mg ozone, i.e. 30 mg additional ozone per kg of dough (with respect to the final wetted dough).

Under these conditions, the global quantity of ozone supplied corresponds to: 1440 mg supplied by the water+2400 mg supplied by the vector gas, i.e. a total of 3840 mg ozone per 80 kg of dough, i.e. an ozone weight of 48 mg per kg of manufactured dough.

As soon as the gas volume was added to the gaseous headspace of the kneading machine, the machine was set in operation at a kneading speed of 80 rpm for 8 minutes. On completion of the kneading time the machine was stopped and simultaneously measurements of kneading energy were recorded. The consumption of electric energy during the two kneading phases such as defined above and in the presence of ozone was 1.2 Kwh.

Experiments previously conducted on the same kneading machine using the same flour and under the same operating conditions but without the use of ozone gave energy consumption readings over the two phases, fraisage and kneading, of 1.5 Kwh.

The use of ozone during the kneading phase and in this specific example therefore shows a reduction in energy consumption in the region of 20% compared with the conventional kneading technique using the same equipment.

Using the dough thus manufactured and obtained, the applicant had loaves manufactured by professionals in accordance with BIPEA methods, and requested the same professionals to comment on the results obtained from which the following were determined:

identical quality for most of the parameters noted;

better dough resistance;

good stretching on shaping;

an increase in bread volume of approximately 12%.

Backed by these results, the Applicant carried out measurements of the possible reduction in rotation speeds using the same equipment and the same operating methods in order to obtain similar results.

It is from examination of the results of several such experiments that the values indicated above in the section on the reduction of energy costs were able to be determined.

1. Method for kneading dough containing soft wheat flour characterized by the fact that the kneading operation is performed in the presence of ozone and by means of at least one mechanical agitator (“fraser”).

2. Method according to claim 1, wherein the ozone is supplied in dissolved form in the wetting water added to the flour.

3. Method according to claim 2, wherein the wetting water containing ozone is prepared from a vector gas containing ozone.

4. Method according to claim 3, wherein the vector gas is air, oxygen or a mixture of these two gases.

5. Method according to claim 2, wherein the ozonated or hyper-ozonated wetting water is prepared using dissolution reactors of the bubbling type equipped with a porous device, operating with or without a pressurized gaseous headspace, using pressure dissolution devices of single or multi-stage hydro-ejector types, or using pressure boosters or compressors of the dry type or liquid ring type.

6. Method according to claim 2, wherein the pressure of the wetting water lies between at least 0.5 absolute bars and no more than 2.2 absolute bars, preferably between at least 1.7 absolute bars and no more than 1.9 absolute bars.

7. Method according to claim 1, wherein ozone is added to the gaseous headspace of the kneading machine.

8. Method according to claim 7, wherein the gaseous headspace containing ozone in the kneading machine is prepared from a vector gas containing ozone.

9. Method according to claim 8, wherein the vector gas is air, oxygen or a mixture of these two gases.

10. Method according to claim 1, wherein the pressure prevailing in the gaseous phase of the kneading machine lies between at least 1.1 absolute bars and no more than 1.6 absolute bars, and preferably between at least 1.3 absolute bars and no more than 1.5 absolute bars.

11. Method according to claim 1, where ozone is supplied in dissolved form in the wetting water added to the flour and in the gaseous headspace of the kneading machine.

12. Method according to claim 1, wherein ozone is added selectively, sequentially, continuously or through the use of successive sequences of ozone supplied by liquid route and ozone supplied by gaseous route.

13. Method according to claim 1, wherein the ratio between the quantity of ozone added to the dough expressed in grams of ozone per hour divided by the quantity of dough produced expressed in kilograms of dough per hour, lies between 0.004 and 0.06.

14. Method according to claim 13, wherein the type of kneading used is conventional, intensive or hyper-intensive.

15. Method according to claim 1, wherein the kneading time is at least 2 minutes.

16. Kneading machine enabling kneading in the presence of ozone comprising a kneading bowl (2) or kneader body (25), frasers (3 or 26) and a driving device (6 or 24), characterized in that it also comprises a gaseous ozone inlet (8 or 30) and/or an inlet for ozonated or hyper-ozonated water (9 or 31).

17. Kneading machine according to claim 16, also characterized in that it comprises a kneading bowl (2) closed by a sealing lid (5), said lid (5) containing a compressible seal (11) allowing the sealed passing of the agitator (3), the kneading machine being adapted for so-called “conventional” kneading with mixing speeds of between 40 and 200 rpm, preferably between 40 and 80 rpm.

18. Kneading machine according to claim 16, characterized in that it comprises a water reservoir (21), a salt reservoir (29), a flour reservoir (22), a yeast reservoir (23), devices for conveying the dough forwards (27) and a dough outlet (28), the kneading machine being adapted for continuous kneading with mixing speeds of between 100 and 600 rpm.
